(19) United States
(12) Patent Application Publication
(10) Pub. No.: US 2014/0119456 A1
(43) Pub. Date: May 1, 2014

(54) ENCODING VIDEO INTO LOWER RESOLUTION STREAMS

(71) Applicant: MICROSOFT CORPORATION, Redmond, WA (US)

(72) Inventor: Lazar Bivolarsky, Cupertino, CA (US)

(73) Assignee: MICROSOFT CORPORATION, Redmond, WA (US)

(21) Appl. No.: 13/666,734

(22) Filed: Nov. 1, 2012

(51) Int. Cl. H04N 7/26

(52) U.S. Cl. 375/240.25; 375/240.01; 375/E07.027; 375/E07.026

(57) ABSTRACT

A transmitting terminal comprises: an input for receiving a video signal comprising a plurality of frames representing a video image at different respective times, each frame comprising a plurality of higher resolution samples; a projection generator configured to generate multiple different projections of the video image, each projection comprising a plurality of lower resolution samples representing the video image at a lower resolution, wherein the lower resolution samples of the different projections represent different but overlapping groups of the higher resolution samples which overlap spatially in a plane of the video image; an encoder configured to encode the video signal by encoding the different projections into separate respective encoded streams; and a transmitter configured to transmit each of the separate encoded streams to a receiving terminal over a network.

### BACKGROUND

In the past, the technique known as “super resolution” has been used in satellite imaging to boost the resolution of the captured image beyond the intrinsic resolution of the image capture element. This can be achieved if the satellite (or some component of it) moves by an amount corresponding to a fraction of a pixel, so as to capture samples that overlap spatially. In the region of overlap, a higher resolution sample can be generated by extrapolating between the values of the two or more lower resolution samples that overlap that region, e.g. by taking an average. The higher resolution sample size is that of the overlapping region, and the value of the higher resolution sample is the extrapolated value.

The idea is illustrated schematically in FIG. 1. Consider the case of a satellite having a single square pixel P which captures a sample from an area of 1 km by 1 km on the ground. If the satellite then moves such that the area captured by the pixel shifts half a kilometre in a direction parallel to one of the edges of the pixel P, and then takes another sample, the satellite then has available two samples covering the overlapping region P′ of width 0.5 km. As this process progresses with samples being taken at 0.5 km intervals in the direction of the shift, and potentially also performing successive sweeps offset by half a pixel perpendicular to the original shift, it is possible to build up an image of resolution 0.5 km by 0.5 km, rather than 1 km by 1 km. It will be appreciated this example is given for illustrative purposes—it is also possible to build up a much finer resolution and to do so from more complex patterns of motion.

More recently the concept of super resolution has been proposed for use in video coding. One potential application of this is similar to the scenario described above—if the user's camera physically shifts between frames by an amount corresponding to a non-integer number of pixels (e.g. because it is a handheld camera), and this motion can be detected (e.g. using a motion estimation algorithm), then it is possible to create an image with a higher resolution than the intrinsic resolution of the camera's image capture element by extrapolating between pixel samples where the pixels of the two frames partially overlap.

Another potential application is to deliberately lower the resolution of each frame and introduce an artificial shift between frames (as opposed to a shift due to actual motion of the camera). This enables the bit rate per frame to be lowered. Referring to FIG. 2, say the camera captures pixels P′ of a certain higher resolution (possibly after an initial quantization stage). Encoding at that resolution in every frame F would incur a certain bitrate. In a first frame F(t) at some time t, the encoder therefore creates a lower resolution version of the frame having pixels of size P, and transmits and encodes these at the lower resolution. For example in FIG. 2 each lower resolution pixel is created by averaging the values of four higher resolution pixels. In the subsequent frame F(t+1), the encoder does the same but with the raster shifted by a fraction of one of the lower resolution pixels, e.g. half a pixel in the horizontal and vertical directions in the example shown. At the decoder, a higher resolution pixel size P′ can then be recreated again by extrapolating between the overlapping regions of the lower resolution samples of the two frames. More complex shift patterns are also possible. For example the pattern may begin at a first position in a first frame, then shift the raster horizontally by half a (lower resolution) pixel in a second frame, then shift the raster in the vertical direction by half a pixel in a third frame, then back by half a pixel in the horizontal direction in a fourth frame, then back in the vertical direction to repeat the cycle from the first position. In this case there are four samples available to extrapolate between at the decoder for each higher resolution pixel to be reconstructed.

### SUMMARY

Embodiments of the present invention receive as an input a video signal comprising a plurality of frames representing a video image at different respective times, each frame comprising a plurality of higher resolution samples. Multiple different projections of the video image are generated, each projection comprising a plurality of lower resolution samples representing the video image at a lower resolution. The lower resolution samples of the different projections represent different but overlapping groups of the higher resolution samples which overlap spatially in a plane of the video image. The video signal is encoded by encoding the different projections into separate respective encoded streams, and each of the separate encoded streams are transmitted to a receiving terminal over a network.

Further embodiments of the present invention decode a video signal comprising a plurality of frames representing a video image at different respective times, each frame comprising a plurality of higher resolution samples. A plurality of separate encoded video streams are received from a transmitting terminal over a network, each of the encoded video streams comprising a different respective one of multiple different projections of the video image. Each projection comprises a plurality of lower resolution samples representing the video image at a lower resolution, wherein the lower resolution samples of the different projections represent different but overlapping groups of the higher resolution samples which overlap spatially in a plane of the video image. The encoded video streams are decoded so as to decode the projections. Higher resolution samples are generated representing the video image at a higher resolution by, for each higher resolution sample thus generated, forming the higher resolution sample from a region of overlap between ones of the lower resolution samples from the different projections. The video signal is output to a screen at the higher resolution following generation from the projections.

The various embodiments may be embodied at a transmitting terminal, receiving terminal system, or as computer program code to be run at the transmitting or receiving side, or may be practiced as a method. The computer program may be embodied on a tangible, computer-readable storage medium.

In further embodiments there may be provided a network element for forwarding a video signal comprising a plurality of frames representing a video image at different respective times, each frame comprising a plurality of higher resolution samples. The network element comprises transceiver apparatus arranged to receive a plurality of separate encoded video streams from a transmitting terminal over a network, each of the encoded video streams comprising a different respective one of multiple different projections of the video image. Each projection comprises a plurality of lower resolution samples representing the video image at a lower resolution, wherein the lower resolution samples of the different projections represent different but overlapping groups of the higher resolution samples which overlap spatially in a plane of the video image. The network element also comprises processing apparatus configured to determine whether to drop at least one of said encoded video streams in dependence on a condition of one of the network, network element and a receiving terminal, leaving one or more of the encoded video streams remaining. The transceiver is arranged to forward the one or more remaining streams to the receiving terminal over the network, but not any of the encoded video streams dropped by the processing apparatus.

### BRIEF DESCRIPTION OF THE DRAWINGS

For a better understanding of the various embodiments and to show how they may be put into effect, reference is made by way of example to the accompanying drawings in which:

FIG. 1 is a schematic representation of a super resolution scheme,

FIG. 2 is another schematic representation of a super resolution scheme,

FIG. 3 is a schematic block diagram of a communication system,

FIG. 4 is a schematic block diagram of an encoder,

FIG. 5 is a schematic block diagram of a decoder,

FIG. 6 is a schematic representation of an encoding system,

FIG. 7 is a schematic representation of a decoding system,

FIG. 8 is a schematic representation of an encoded video signal comprising a plurality of streams,

FIG. 9 is a schematic representation of a video signal to be encoded,

FIG. 10 is another schematic representation of a video signal to be encoded,

FIG. 11 is a schematic representation of the addition of a motion vector with a super resolution shift, and

FIG. 12 is another schematic representation of a video signal to be encoded.

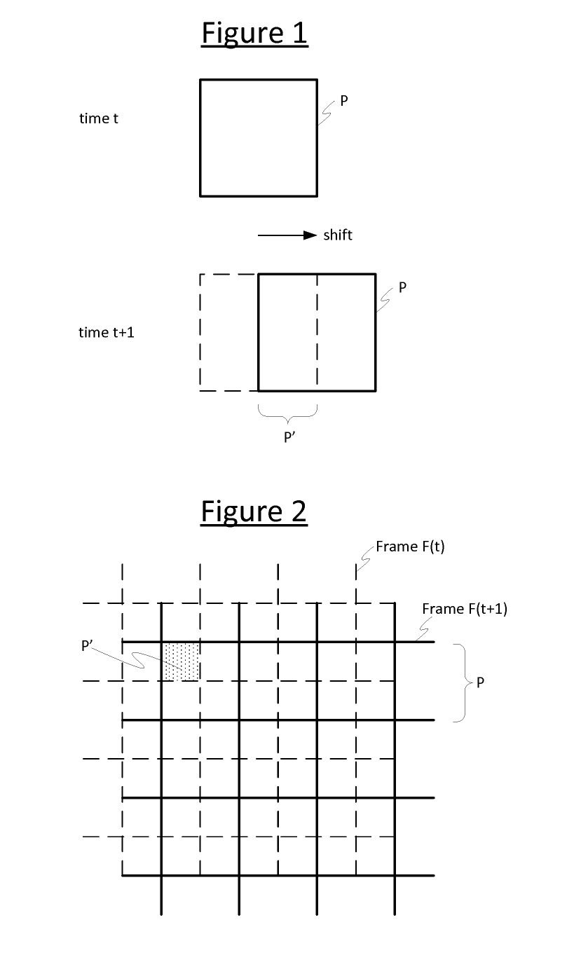

### DETAILED DESCRIPTION

Embodiments of the present invention provide a super-resolution based compression technique for use in video coding. Over a sequence of frames, the image represented in the video signal is divided into a plurality of different lower resolution “projections” from which a higher resolution version of the frame can be reconstructed. Each projection is a version of a different respective one of the frames, but with a lower resolution than the original frame. The lower resolution samples of each different projection have different spatial alignments relative to one another within a reference grid of the video image, so that the lower resolution samples of the different projections overlap but are not coincident. For example each projection is based on the same raster grid defining the size and shape of the lower resolution samples, but with the raster being applied with a different offset or “shift” in each of the different projections, the shift being a fraction of the lower resolution sample size in either the horizontal and/or vertical direction relative to the raster orientation. Each frame is subdivided into only one projection regardless of shift step, e.g. ½ or ¼ pixel.

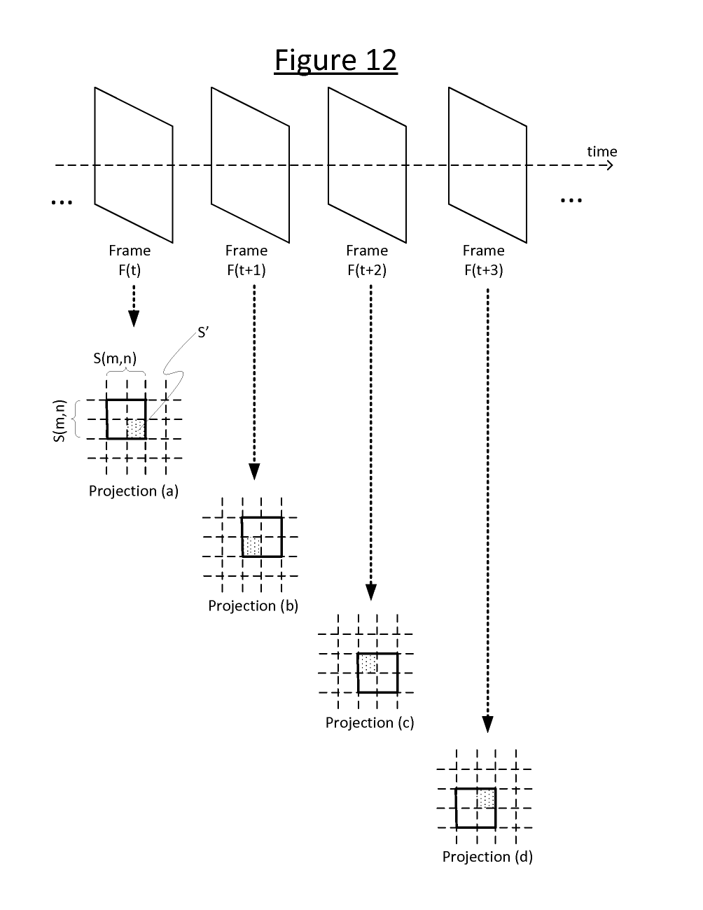

An example is illustrated schematically in FIG. 12. Illustrated at the top of the page is a video signal to be encoded, comprising a plurality of frames F each representing the video image at successive moments in time t, t+1, t+2, t+3 . . . (where time is measured as a frame index and t is any arbitrary point in time).

A given frame F(t) comprises a plurality of higher resolution samples S′ defined by a higher resolution raster shown by the dotted grid lines in FIG. 12. A raster is a grid structure which when applied to a frame divides it into samples, each sample being defined by a corresponding unit of the grid. Note that a sample does not necessarily mean a sample of the same size as the physical pixels of the image capture element, nor the physical pixel size of a screen on which the video is to be output. For example, samples could be captured at an even higher resolution, and then quantized down to produce the samples S′.

Each of a sequence of frames F(t), F(t+1), F(t+2), F(t+3) is then converted into a different respective projection (a) to (d). Each of the projections of comprises a plurality of lower resolution samples S defined by applying a lower resolution raster to the respective frame, as illustrated by the solid lines overlaid on the higher resolution grid of in FIG. 12. Again the raster is a grid structure which when applied to a frame divides it into samples. Each lower resolution sample S represents a group of the higher resolution samples S′, with the grouping depending on the grid spacing and alignment of the lower resolution raster, each sample being defined by a corresponding unit of the grid. The grid may be a square or rectangular grid, lower resolution samples may be square or rectangular in shape (as are the higher resolution samples), though that does not necessarily have to be the case. In the example shown, each lower resolution sample S covers a respective two-by-two square of four higher resolution samples S′. Another example would be a four-by-four square of sixteen.

Each lower resolution sample S represents a respective group of higher resolution samples S′ (each lower resolution sample covers a whole number of higher resolution samples). In embodiments the value of the lower resolution sample S is determined by combining the values of the higher resolution samples, for example by taking an average such as a mean or weighted mean (although more complex relationships are not excluded). Alternatively the value of the lower resolution sample could be determined by taking the value of a representative one of the higher resolution samples, or averaging a representative subset of the higher resolution values.

The grid of lower resolution samples in the first projection (a) has a certain, first alignment relative to the underlying higher-resolution raster of the video image represented in the signal being encoded, in the plane of the frame. For reference this may be referred to here as a shift of (0, 0). The grid of lower resolution samples formed by each further projection (b) to (d) of the subsequent frames F(t+1), F(t+2), F(t+3) respectively is then shifted by a different respective amount in the plane of the frame. For each successive projection, the shift is by a fraction of the lower resolution sample size in the horizontal or vertical direction. In the example shown, in the second projection (b) the lower resolution grid is shifted right by half a (lower resolution) sample, i.e. a shift of (+½, 0) relative to the reference position (0, 0). In the third projection (c) the lower resolution grid is shifted down by another half a sample, i.e. a shift of (0, +½) relative to the second shift or a shift of (+½, +½) relative to the reference position. In the fourth projection the lower resolution grid is shifted left by another half a sample, i.e. a shift of (−½, 0) relative to the third projection or (0, +½) relative to the reference position. Together these shifts make up a shift pattern.

In FIG. 12 this is illustrated by reference to a lower resolution sample S(m, n) of the first projection (a), where m and n are coordinate indices of the lower resolution grid in the horizontal and vertical directions respectively, taking the grid of the first projection (a) as a reference. A corresponding, shifted lower resolution sample being a sample of the second projection (b) is then located at position (m, n) within its own respective grid which corresponds to position (m+½, n) relative to the first projection. Another corresponding, shifted lower resolution sample being a sample of the third projection (c) is located at position (m, n) within the respective grid of the third projection which corresponds to position (m+½, n+½) relative to the grid of the first projection. Yet another corresponding, shifted lower resolution sample being a sample of the fourth projection (d) is located at its own respective position (m, n) which corresponds to position (m, n+½) relative to the first projection. Each projection is formed in a different respective frame.

The value of the lower resolution sample in each projection is taken by combining the values of the higher resolution samples covered by that lower resolution sample, i.e. by combining the values of the respective group of lower resolution samples which that higher resolution sample represents. This is done for each lower resolution sample of each projection based on the respective groups, thereby generating a plurality of different reduced-resolution versions of the image over a sequence of frames.

The pattern repeats over multiple sequences of frames. The projection of each frame is encoded and sent to a decoder in an encoded video signal, e.g. being transmitted over a packet-based network such as the Internet. Alternatively the encoded video signal may be stored for decoding later by a decoder.

At the decoder, the different projections of the sequence of frames can then be used reconstruct a higher resolution sample size from the overlapping regions of the lower resolution samples. For example, in the embodiment described in relation to FIG. 12, any group of four overlapping samples from the different projections defines a unique intersection. The shaded region S′ in FIG. 12 corresponds to the intersection of the lower resolution samples S(m, n) from projections (a), (b), (c) and (d). The value of the higher resolution sample corresponding to this overlap or intersection can be found by extrapolating between the values of the lower resolution samples that overlap at the region in question, e.g. by taking an average such as a mean or weighted mean. Each of the other higher resolution samples can be found from a similar intersection of lower resolution samples.

Over a sequence of frames the video image may be subdivided into a full set of projections, e.g. when the shift is half a sample there are provided four projections over a sequence of four frames, and in the case of a quarter shift sixteen projections over sixteen frames. Therefore overall, the frame including all its projections together may still recreate the same resolution as if the super resolution technique was not applied, albeit taking longer to build up that resolution.

However, the video image is broken down into separate descriptions or sub-frames, which can be manipulated separately or differently. There are a number of uses for the division of the video into multiple projections, for example as follows.
Each projection is encoded separately as an individual stream. At least one or some, and potentially all, of the projections are encoded in their own right, not relative to any other one of the streams, i.e. are independently decodable.
Following from this, to enhance robustness the different projections are sent as separate respective streams over the network. Thus if one or some of the streams are lost in transmission, or deliberately dropped, the decoder can still recreate at least a lower resolution version of the video from the one or more streams that remain.
There is provided a new opportunity for scaling by omitting or dropping one or more projections, i.e. a new form of layered coding.
There are provided further opportunities for prediction coding, by predicting between different projections in different frames so as to encode the projection of one frame relative to another, base one of the projections of a preceding frame.
In the case of predictions between the projections of different frames, the stream carrying the base projection (which is used for predicting the other projections) may be tagged as a high priority. This may help the network layer in determining when to drop the rest of the projections and reconstruct the frame from the base layer only.
The number of bits incurred in the encoded signal per frame is reduced.

Note also that, in embodiments, the multiple projections are created by a predetermined shift pattern, not signalled over the network from the encoder to the decoder and not included in the encoded bitstream. The order of the projection may determine the shift position in combination with the shift pattern. That is, each of said projections may be of a different respective one of a sequence of said frames, and the projection of each of said sequence of frames may be a respective one of a predetermined pattern of different projections, wherein said pattern repeats over successive sequences of said frames. The decoder is then configured to regenerate a higher resolution version of the video based on the predetermined pattern being pre-stored or pre-programmed at the receiving terminal rather than received from the transmitting terminal in any of the streams.

Alternative embodiments of the present invention divide a given frame into a plurality of different lower resolution projections from which a higher resolution version of the frame can be reconstructed. Each projection is a version the same frame with a lower resolution than the original frame. The lower resolution samples of each different projection of the same frame have different spatial alignments relative to one another within the frame, so that the lower resolution samples of the different projections overlap but are not coincident. For example each projection is based on the same raster grid defining the size and shape of the lower resolution samples, but with the raster being applied with a different offset or “shift” in each of the different projections, the shift being a fraction of the lower resolution sample size in either the horizontal and/or vertical direction relative to the raster orientation.

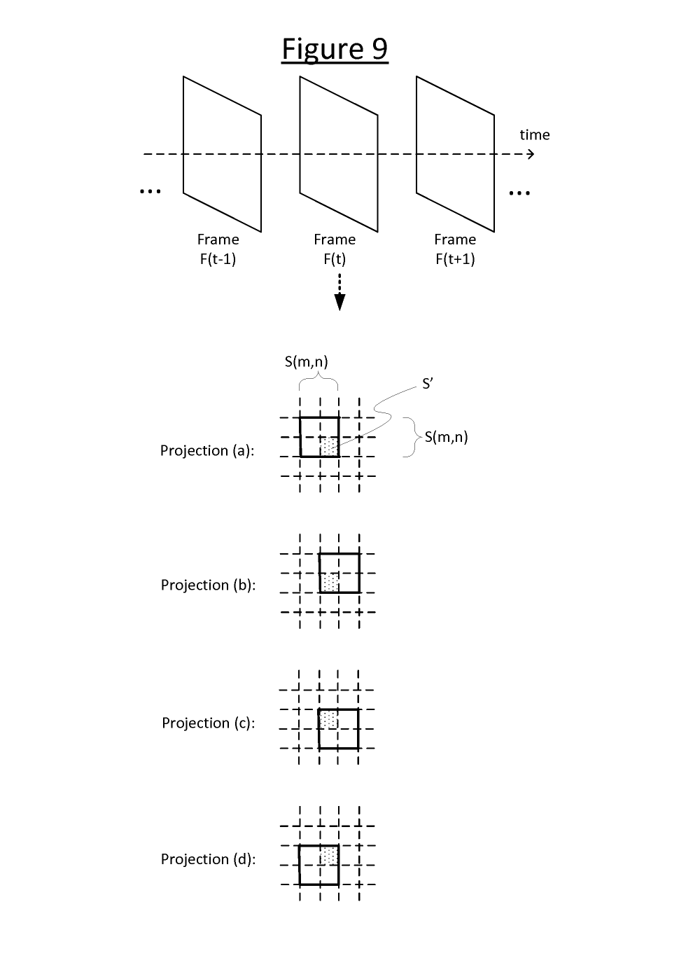

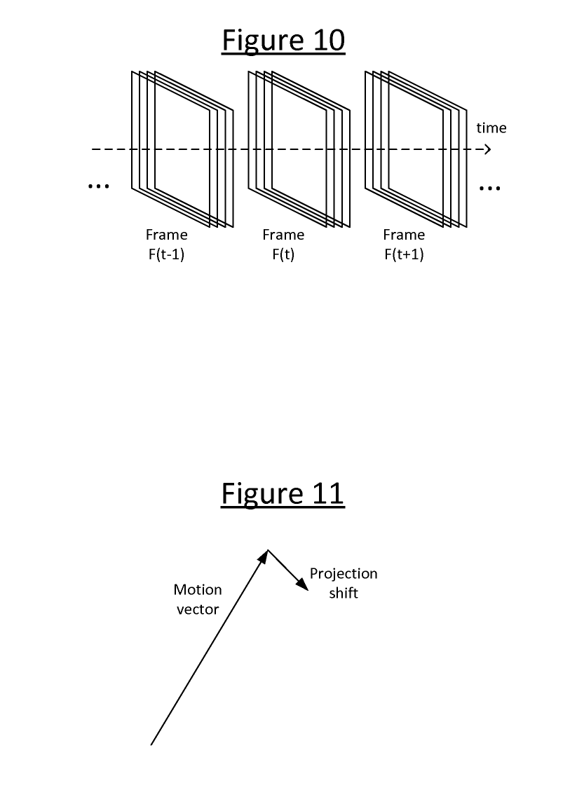

An example is shown schematically in FIGS. 9 and 10. Illustrated at the top of the page is a video signal to be encoded, comprising a plurality of frames F each representing the video image at successive moments in time . . . t−1, t, t+1, . . . (where time is measured as a frame index and t is any arbitrary point in time).

A given input frame F(t) comprises a plurality of higher resolution samples S′ defined by a higher resolution raster shown by the dotted grid lines in FIG. 9. The same frame F(t) is then split into a plurality of different projections (a) to (d). Each of the projections of this same frame F(t) comprises a plurality of lower resolution samples S defined by applying a lower resolution raster to the frame, as illustrated by the solid lines overlaid on the higher resolution grid of in FIG. 9. Each lower resolution sample S represents a group of the higher resolution samples S′, with the grouping depending on the grid spacing and alignment of the lower resolution raster, each sample being defined by a corresponding unit of the grid.

Similarly to the embodiments described in relation to FIG. 12, each lower resolution sample S represents a respective group of higher resolution samples S′ (each lower resolution sample covers a whole number of higher resolution samples). The value of the lower resolution sample S may be determined by combining the values of the higher resolution samples, in embodiments by taking an average such as a mean or weighted mean (although more complex relationships are not excluded); or alternatively by taking the value of a representative one of the higher resolution samples, or averaging a representative subset of the higher resolution values.

The grid of lower resolution samples in the first projection (a) has a certain, first alignment within the frame F(t), i.e. in the plane of the frame. For reference this may be referred to here as a shift of (0, 0). The grids of lower resolution samples formed by each further projection (b) to (d) of the same frame F(t) is then shifted by a different respective amount in the plane of the frame. For each successive projection, the shift is by a fraction of the lower resolution sample size in the horizontal or vertical direction. In the example shown, similar to the pattern of FIG. 12, in the second projection (b) the lower resolution grid is shifted right by half a (lower resolution) sample, i.e. a shift of (+½, 0) relative to the reference position (0, 0). In the third projection (c) the lower resolution grid is shifted down by another half a sample, i.e. a shift of (0, +½) relative to the second shift or a shift of (+½, +½) relative to the reference position. In the fourth projection the lower resolution grid is shifted left by another half a sample, i.e. a shift of (−½, 0) relative to the third projection or (0, +½) relative to the reference position. Together these shifts make up a shift pattern. However in this embodiment the shifts are all applied within different frames, rather than from one frame to the next.

In FIG. 9 this is illustrated by reference to a lower resolution sample S(m, n) of the first projection (a), again where m and n are coordinate indices of the lower resolution grid in the horizontal and vertical directions respectively, taking the grid of the first projection (a) as a reference. Similarly to the pattern described in relation to FIG. 12, a corresponding, shifted lower resolution sample being a sample of the second projection (b) is then located at position (m, n) within its own respective grid which corresponds to position (m+½, n) relative to the first projection. Another corresponding, shifted lower resolution sample being a sample of the third projection (c) is located at position (m, n) within the respective grid of the third projection which corresponds position (m+½, n+½) relative to the grid of the first projection. Yet another corresponding, shifted lower resolution sample being a sample of the fourth projection (d) is located at its own respective position (m, n) which corresponds to position (m, n+½) of the first projection. However in this embodiment each projection is formed from the same frame, rather than in successive frames.

Note that the different projections within the same frame do not necessarily need to be generated in any particular order, and any could be considered the “reference position”. Other ways of describing the same pattern may be equivalent. Other patterns are also possible, e.g. based on a lower resolution sample size of 4×4 higher resolution samples being shifted in a pattern of quarter sample shifts (a quarter of the lower resolution sample size).

Again, the value of the lower resolution sample in each projection is taken by combining the values of the higher resolution samples covered by that lower resolution sample, i.e. by combining the values of the respective group of lower resolution samples which that higher resolution sample represents. This is done for each lower resolution sample of each projection based on the respective groups, thereby generating a plurality of different reduced-resolution versions of the same frame. The process is also repeated for multiple frames.

The effect is that each two dimensional frame now effectively becomes a three dimensional “slab” or cuboid, as shown schematically in FIG. 10.

The projections of each frame are encoded and sent to a decoder in an encoded video signal, e.g. being transmitted over a packet-based network such as the Internet. Alternatively the encoded video signal may be stored for decoding later by a decoder.

At the decoder, the multiple different projections of the same frame can then be used reconstruct a higher resolution sample size from the overlapping regions of the lower resolution samples. For example, in the embodiment described in relation to FIG. 9, any group of four overlapping samples from the different projections defines a unique intersection. The shaded region S′ in FIG. 9 corresponds to the intersection of the lower resolution samples S(m, n) from projections (a), (b), (c) and (d). The value of the higher resolution sample corresponding to this overlap or intersection can be found by extrapolating between the values of the lower resolution samples that overlap at the region in question, e.g. by taking an average such as a mean or weighted mean. Each of the other higher resolution samples can be found from a similar intersection of lower resolution samples.

Each frame may be subdivided into a full set of projections, e.g. when the shift is half a sample each frame is represented in four projections, and in the case of a quarter shift into sixteen projections. Therefore overall, the frame including all its projections together may still represent the same resolution as if the super resolution technique was not applied.

However, unlike a conventional video coding scheme the frame is broken down into separate descriptions or sub-frames, which can be manipulated separately or differently. There are a number of uses for this, for example as follows.
Again, each projection may be encoded separately as an individual stream.
Again to enhance robustness each projection is sent as a separate stream over the network.
There are provided further opportunities for scaling.
There are provided further opportunities for prediction coding, by predicting between projections of the same frame so as to encode one or more of the projections of the frame relative to another, base one of the projections of that frame.
To enhance robustness, different projections could be used as a base projection.
The selection of base projection may be determined so as to optimize a property of the stream, e.g. to reduce the residual (in embodiments minimize it) so as to reduce the bitrate in the encoded signal.
In the case of predictions between the projections, the base projection (which is used for predicting the other projections) may be tagged as a high priority. This may help the network layer in determining when to drop the rest of the projections and reconstruct the frame from the base layer only.

Also, again the multiple projections may be created by a predetermined shift pattern, not signalled over the network from the encoder to the decoder and not included in the encoded bitstream.

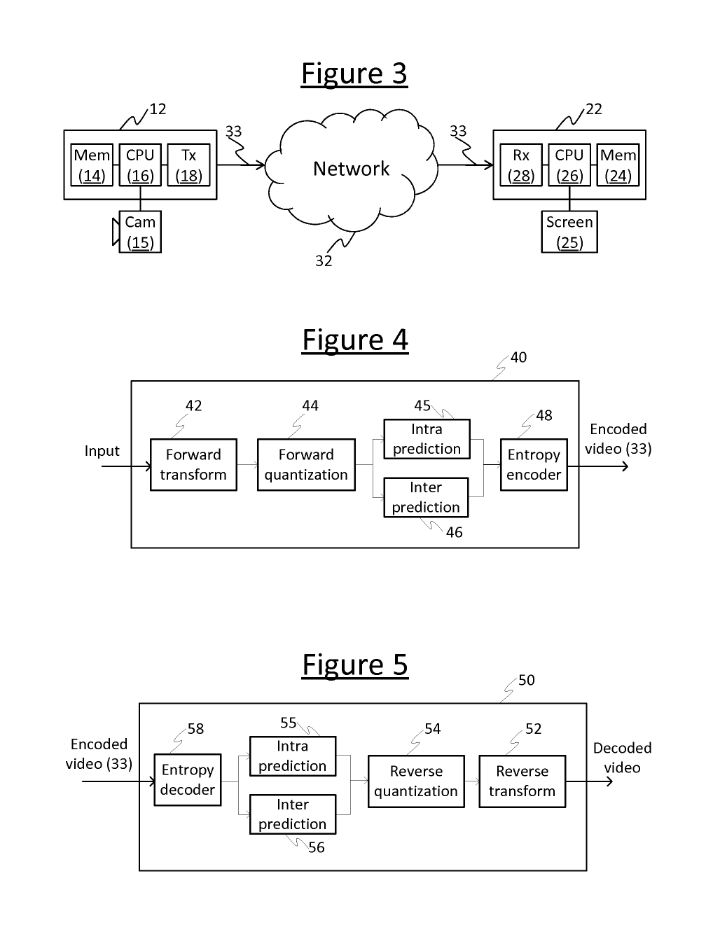

An example communication system in which the various embodiments may be employed is described with reference to the schematic block diagram of FIG. 3.

The communication system comprises a first, transmitting terminal 12 and a second, receiving terminal 22. For example, each terminal 12, 22 may comprise one of a mobile phone or smart phone, tablet, laptop computer, desktop computer, or other household appliance such as a television set, set-top box, stereo system, etc. The first and second terminals 12, 22 are each operatively coupled to a communication network 32 and the first, transmitting terminal 12 is thereby arranged to transmit signals which will be received by the second, receiving terminal 22. Of course the transmitting terminal 12 may also be capable of receiving signals from the receiving terminal 22 and vice versa, but for the purpose of discussion the transmission is described herein from the perspective of the first terminal 12 and the reception is described from the perspective of the second terminal 22. The communication network 32 may comprise for example a packet-based network such as a wide area internet and/or local area network, and/or a mobile cellular network.

The first terminal 12 comprises a tangible, computer-readable storage medium 14 such as a flash memory or other electronic memory, a magnetic storage device, and/or an optical storage device. The first terminal 12 also comprises a processing apparatus 16 in the form of a processor or CPU having one or more cores; a transceiver such as a wired or wireless modem having at least a transmitter 18; and a video camera 15 which may or may not be housed within the same casing as the rest of the terminal 12. The storage medium 14, video camera 15 and transmitter 18 are each operatively coupled to the processing apparatus 16, and the transmitter 18 is operatively coupled to the network 32 via a wired or wireless link. Similarly, the second terminal 22 comprises a tangible, computer-readable storage medium 24 such as an electronic, magnetic, and/or an optical storage device; and a processing apparatus 26 in the form of a CPU having one or more cores. The second terminal comprises a transceiver such as a wired or wireless modem having at least a receiver 28; and a screen 25 which may or may not be housed within the same casing as the rest of the terminal 22. The storage medium 24, screen 25 and receiver 28 of the second terminal are each operatively coupled to the respective processing apparatus 26, and the receiver 28 is operatively coupled to the network 32 via a wired or wireless link.

The storage medium 14 on the first terminal 12 stores at least a video encoder arranged to be executed on the processing apparatus 16. When executed the encoder receives a “raw” (unencoded) input video signal from the video camera 15, encodes the video signal so as to compress it into a lower bitrate stream, and outputs the encoded video for transmission via the transmitter 18 and communication network 32 to the receiver 28 of the second terminal 22. The storage medium on the second terminal 22 stores at least a video decoder arranged to be executed on its own processing apparatus 26. When executed the decoder receives the encoded video signal from the receiver 28 and decodes it for output to the screen 25. A generic term that may be used to refer to an encoder and/or decoder is a codec.

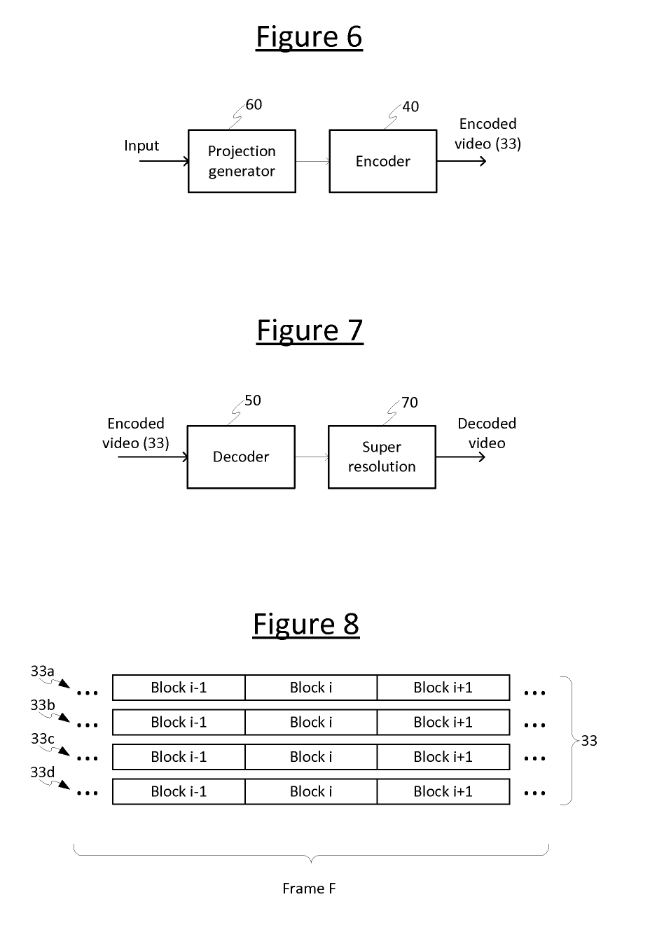

FIG. 6 gives a schematic block diagram of an encoding system that may be stored and run on the transmitting terminal 12. The encoding system comprises a projection generator 60 and an encoder 40, in embodiments being implemented as modules of software (though the option of some or all of the functionality being implemented in dedicated hardware circuitry is not excluded). The projection generator has an input arranged to receive an input video signal from the camera 15, comprising series of frames to be encoded as illustrated at the top of FIG. 12 or 9. The encoder 40 has an input operatively coupled to an output of the projection generator 60, and an output arranged to supply an encoded version of the video signal to the transmitter 18 for transmission over the network 32.

FIG. 4 gives a schematic block diagram of the encoder 40. The encoder 40 comprises a forward transform module 42 operatively coupled to the input from the projection generator 60, a forward transform module 44 operatively coupled to the forward transform module 42, an intra prediction coding module 45 and an inter prediction (motion prediction) coding module 46 each operatively coupled to the forward quantization module 44, and an entropy encoder 48 operatively coupled to the intra and inter prediction coding modules 45 and 46 and arranged to supply the encoded output to the transmitter 18 for transmission over the network 32.

In operation, the projection generator 60 sub-divides the input video signal into a plurality of projections, either generating a respective projection for each successive frame as discussed above in relation to FIG. 12, or subdividing each frame into a plurality of projections in the manner discussed above in relation to FIGS. 9 and 10. Each projection is individually passed through the encoder 40 and treated as a separate stream. For encoding each projection may be divided into a plurality of blocks (each comprising a plurality of the lower resolution samples S).

Within a given projection, the forward transform module 42 transforms each block of lower resolution samples from a spatial domain representation into a transform domain representation, typically a frequency domain representation, so as to convert the samples of the block to a set of transform domain coefficients. Examples of such transforms include a Fourier transform, a discrete cosine transform (DCT) and a Karhunen-Loève transform (KLT) details of which will be familiar to a person skilled in the art. The transformed coefficients of each block are then passed through the forward quantization module 44 where they are quantized onto discrete quantization levels (coarser levels than used to represent the coefficient values initially). The transformed, quantized blocks are then encoded through the prediction coding stage 45 or 46 and then a lossless encoding stage such as an entropy encoder 48.

The effect of the entropy encoder 48 is that it requires fewer bits to encode smaller, frequently occurring values, so the aim of the preceding stages is to represent the video signal in terms of as many small values as possible.

The purpose of the quantizer 44 is that the quantized values will be smaller and therefore require fewer bits to encode. The purpose of the transform is that, in the transform domain, there tend to be more values that quantize to zero or to small values, thereby reducing the bitrate when encoded through the subsequent stages.

The encoder may be arranged to encode in either an inter prediction coding mode or an inter prediction coding mode (i.e. motion prediction). If using inter prediction, the inter prediction module 46 encodes the transformed, quantized coefficients from a block of one frame F(t) relative to a portion of a preceding frame F(t−1). The block is said to be predicted from the preceding frame. Thus the encoder only needs to transmit a difference between the predicted version of the block and the actual block, referred to in the art as the residual, and the motion vectors. Because the residual values tend to be smaller, they require fewer bits to encode when passed through the entropy encoder 48.

The location of the portion of the preceding frame is determined by a motion vector, which is determined by the motion prediction algorithm in the inter prediction module 46.

In embodiments a block from one projection of one frame is predicted from a different projection having a different shift in a preceding frame. E.g. referring to FIG. 12, a block from projection (b), (c) and/or (d) of frames F(t+1), F(t+2) and/or F(t+3) respectively is predicted from a portion of projection (a) in frame F(t−1); or referring to FIG. 9 a block from projection (b), (c) and/or (d) of frame F(t) is predicted from a portion of projection (a) in frame F(t−1). Thus the encoder only need to encode all but one of the projections in terms of a residual relative to the base projection. In such cases of prediction between different projections, the motion vector representing the motion between frames may be added to a vector representing the shift between the different projections, in order to obtain the correct prediction. This is illustrated schematically in FIG. 11.

Alternatively in embodiments of the present invention in which frames are each split into a plurality of projections, the motion prediction may be between two corresponding projections from different frames, i.e. between projections having the same shift within their respective frames. For example referring to FIG. 9, blocks from projection (a) of Frame F(t) may be predicted from projection (a) of frame F(t−1), blocks from projection (b) of Frame F(t) may be predicted from projection (b) of frame F(t−1), and so forth.

If using inter prediction, the transformed, quantized samples are subject instead to the intra prediction module 45. In this case the transformed, quantized coefficients from a block of the current frame F(t) are encoded relative to a block within the same frame, typically a neighbouring block. The encoder then only needs to transmit the residual difference between the predicted version of the block and the neighbouring block. Again, because the residual values tend to be smaller they require fewer bits to encode when passed through the entropy encoder 48.

In embodiments of the present invention, the intra prediction module 45 predicts between blocks of the same projection in the same frame, e.g. in the case of FIG. 12. Alternatively the intra prediction module 45 may predict between blocks from different projections of the same frame. That is, a block from one or more of the projections is encoded relative to a corresponding block in a base one of the projections. For example each lower resolution sample in one or more of the projections may be predicted from its counterpart sample in the base projection, e.g. so that the lower resolution sample S(m, n) in projection (b), (c) and (d) are each predicted from the sample S(m, n) in the first projection (a) and similarly for the other samples of each block. Thus the encoder only need to encode all but one of the projections in terms of a residual relative to the base projection.

The prediction may present more opportunities for reducing the size of the residual, because corresponding counterpart samples from the different projections will tend to be similar and therefore result in a small residual. In embodiments the intra prediction module 45 may be configured to select which of the projections to use as the base projection and which to encode relative to the base projection. E.g. so the intra prediction module could instead choose projection (c) as the base projection and then encode projections (a), (b) and (d) relative to projection (c). The intra prediction module 45 may be configured to select which is the base projection in order to minimize or at least reduce the residual, e.g. by trying all or a subset of possibilities and selecting that which results in the smallest overall residual bitrate to encode.

Once encoded by the intra prediction coding module 45 or inter prediction coding module 46, the blocks of samples of the different projections are passed to the entropy encoder 48 where they are subject to a further, lossless encoding stage. The encoded video output by the entropy encoder 48 is then passed to the transmitter 18, which transmits the encoded video 33 to the receiver 28 of the receiving terminal 22 over the network 32, in embodiments a packet-based network such as the Internet.

FIG. 7 gives a schematic block diagram of a decoding system that may be stored and run on the receiving terminal 22. The decoding system comprises a decoder 50 and a super resolution module 70, in embodiments being implemented as modules of software (though the option of some or all of the functionality being implemented in dedicated hardware circuitry is not excluded). The decoder 50 has an input arranged to receive the encoded video from the receiver 28, and an output operatively coupled to the input of a super resolution module 70. The super resolution module 70 has an output arranged to supply decoded video to the screen 25.

FIG. 5 gives a schematic block diagram of the decoder 50. The decoder 50 comprises an entropy decoder 58, and intra prediction decoding module 55 and an inter prediction (motion prediction) decoding module 54, a reverse quantization module 54 and a reverse transform module 52. The entropy decoder 58 is operatively coupled to the input from the receiver 28. Each of the intra prediction decoding module 55 and inter prediction decoding module 56 is operatively coupled to the entropy decoder 58. The reverse quantization module 54 is operatively coupled to the intra and inter prediction decoding modules 55 and 56, and the reverse transform module 52 is operatively coupled to the reverse quantization module 54. The reverse transform module is operatively coupled to supply the output to the super resolution module 70.

In operation, each projection is individually passed through the decoder 50 and treated as a separate stream.

The entropy decoder 58 performs a lossless decoding operation on each projection of the encoded video signal 33 in accordance with entropy coding techniques, and passes the resulting output to either the intra prediction decoding module 55 or the inter prediction decoding module 56 for further decoding, depending on whether intra prediction or inter prediction (motion prediction) was used in the encoding.

If inter prediction was used, the inter prediction module 56 uses the motion vector received in the encoded signal to predict a block from one frame based on a portion of a preceding frame. As discussed, this prediction could be between different projections of different frames, or the same projection in different frames. In the former case the motion vector and shift are added as shown in FIG. 11.

If intra prediction was used, the intra prediction module 55 predicts a block from another block in the same frame. In embodiments, this comprises predicting blocks of one projection based on blocks of another, base projection.

The decoded projections are then passed through the reverse quantization module 54 where the quantized levels are converted onto a de-quantized scale, and the reverse transform module 52 where the de-quantized coefficients are converted from the transform domain into lower resolution samples in the spatial domain. The dequantized, reverse transformed samples are supplied on to the super resolution module 70.

The super resolution module uses the lower resolution samples from the different projections of the same frame to “stich together” a higher resolution version of the video image represented by the signal being decoded. As discussed, this can be achieved by taking overlapping lower resolution samples from different projections (either from different frames or the same frame), and generating a higher resolution sample corresponding to the region of overlap. The value of the higher resolution sample is found by extrapolating between the values of the overlapping lower resolution samples, e.g. by talking an average. E.g. see the shaded region overlapped by four lower resolution samples S from the four different projections (a) to (d) in FIGS. 12 and 9. This allows a higher resolution sample S′ to be reconstructed at the decoder side.

In other embodiments, the process may involve some degradation. For example this may be the case if each lower resolution sample represents four higher resolution samples of the original input frame, but the four projections with shifts of (0,0); (0, +½); (−½, +½); and (+½, 0) are spread out in time over different successive frames as in FIG. 12. In this case a unique combination of four lower resolution samples from four different projections is available at the decoder for every higher resolution sample to be recreated, and the higher resolution sample size reconstructed at the decoder side may be the same as the higher resolution sample size of the original input frame at the encoder side. However, the data used to achieve this resolution is spread out over time so that information is lost in the time domain. Another example occurs if only two projections are created e.g. with shifts of (0,0) and (+½, +½). In this case information is also lost. However, in either case the loss may be considered tolerable perceptually. Generally the higher resolution samples reconstructed at the decoder side need not be as high as the higher resolution sample size of the original input frame at the encoder side

In other embodiments the process of reconstructing the frame from a plurality of projections may be lossless. For example this may be the case if each lower resolution sample represents four higher resolution samples of the original input frame as shown in FIG. 9, and four projections are created e.g. with shifts of (0,0); (0, +½); (+½, +½); and (+½, 0) respectively. This means a unique combination of four lower resolution samples from four different projections will be available at the decoder for every higher resolution sample to be recreated. In this case the higher resolution sample size reconstructed at the decoder side may be the same as the higher resolution sample size of the original input frame at the encoder side.

This process is performed over all frames in the video signal being decoded. If different projections are provided in different frames as in FIG. 12, the decoder repeats the pattern over multiple sequences of frames. The reconstructed, higher resolution frames output for supply to the screen 25 so that the video is displayed to the user of the receiving terminal 22.

The different projections are transmitted over the network 32 from the transmitting terminal 12 to the receiving terminal 22 in separate packet streams. Thus each projection is transmitted in a separate set of packets making up the respective stream, in embodiments being distinguished by a separate stream identifier for each stream included in the packets of that stream. At least one of the streams is independently encoded, i.e. using a self-contained encoding, not relative to any others of the streams carrying the other projections. In embodiments more or all of the streams may be encoded in this way, or alternatively some others may be encoded relative to a base projection in one of the streams.

FIG. 8 gives a schematic representation of an encoded video signal 33 as would be transmitted from the encoder running on the transmitting terminal 12 to the decoder running on the receiving terminal 22. The encoded video signal 33 comprises a plurality of encoded, quantized samples for each block. Further, the encoded video signal is divided into separate streams 33a, 33b, 33c and 33d carrying the different projections (a), (b), (c), (d) respectively. In one application, the encoded video signal may be transmitted as part of a live (real-time) video phone call such as a VoIP call between the transmitting and receiving terminals 12, 22 (VoIP calls can also include video).

A result of transmitting in different streams is that one or more of the streams can be dropped, or packets of those streams dropped, and it is still possible to decode at least a lower resolution version of the video from one of the remaining projections, or potentially a higher (but not full) resolution version from a subset of remaining projections. The streams or packets may be deliberately dropped, or may be lost in transmission.

Projections may be dropped at various stages of transmission for various reasons. Projections may be dropped by the transmitting terminal 12. It may be configured to do this in response to feedback from the receiving terminal 22 that there are insufficient resources at the receiving terminal (e.g. insufficient processing cycles or downlink bandwidth) to handle a full or higher resolution version of the video, or that a full or higher resolution is not necessarily required by a user of the receiving terminal; or in response to feedback from the network 32 that there are insufficient resources at one or more elements of the network to handle a full or higher resolution version of the video, e.g. there is network congestion such that one or more routers have packet queues full enough that they discard packets or whole streams, or an intermediate server has insufficient processing resources or up or downlink bandwidth. Another case of dropping may occur where the transmitting terminal 12 does not have enough resources to encode at a full or higher resolution (e.g. insufficient processing cycles or uplink bandwidth). Alternatively or additionally, one or more of the streams carrying the different projections may be dropped by an intermediate element of the network 32 such as a router or intermediate server, in response to network conditions (e.g. congestion) or information from the receiving terminal 22 that there are insufficient resources to handle a full or higher resolution or that such resolution is not necessarily required at the receiving terminal 22.

For example, say a signal is split into four projections (a) to (d) at the encoder side, each in a separate stream. If the receiving terminal 22 receives all four streams, the decoding system can recreate a full resolution version of that frame. If however one or more streams are dropped, e.g. the streams carrying projections (b) and (d), the decoding system can still reconstruct a higher (but not full) resolution version of the video by extrapolating only between overlapping samples of the projections (a) and (c) from the remaining streams. Alternatively if only one stream remains, e.g. carrying projection (a), this can be used alone to display only a lower resolution version of the frame. Thus there may be provided a new form of layered or scaled coding based on splitting a video signal into different projections.

If prediction between projections is used then the base projection will not be dropped if it can be avoided, but one, some or all of the other projections predicted from the base projection may be dropped. To this end, the base projection may be marked as a priority by including a tag as side information in the encoded stream of the base projection. Elements of the networks 32 such as routers or servers may then be configured to read the tag (or note the absence of it) to determine which streams can be dropped and which should not be dropped if possible (i.e. dropping the higher priority base stream should be avoided).

In some embodiments a hierarchical prediction could be used, whereby one projection is predicted from the base projection, then one or more further projections are predicted in turn from each previously predicted projection. E.g. so a second projection (b) may be predicted from a first projection (a), and a third projection (c) may be predicted from the second projection (b), and in turn a fourth projection (d) may be predicted from the projection (c). Further levels may be included if there are more than four projections. Each projection may be tagged with a respective priority corresponding to its order in the prediction hierarchy, and any dropping of projections or the streams carrying the projections may be performed in dependence on this hierarchical tag.

In embodiments the encoder uses a predetermined shift pattern that is assumed by both the encoder side and decoder side without having to be signalled between them, over the network, e.g. both being pre-programmed to use a pattern such as (0,0); (0, +½); (+½, +½); (+½, 0) as described above in relation to FIGS. 12 and 9. In this case it is not necessary to signal the shift pattern to the decoder side in the encoded stream or streams. A result of this is that there is no concern that a packet or stream containing the indication of a shift might be lost or dropped, which would otherwise cause a breakdown in the reconstruction scheme at the decoder.

Alternatively if the encoding system is configured to select which to use as a base projection, it may be that an indication concerning the shift pattern is included in the encoded signal. If any expected indication is lost in transmission, the decoding system may be configured to use a default one of the projections alone so at least to be able to display a lower resolution version.

It will be appreciated that the above embodiments have been described only by way of example.

For instance, the various embodiments are not limited to lower resolutions samples formed from 2×2 or 4×4 samples corresponding samples nor any particular number, nor to square or rectangular samples nor any particular shape of sample. The grid structure used to form the lower resolution samples is not limited to being a square or rectangular grid, and other forms of grid are possible. Nor need the grid structure define uniformly sized or shaped samples. As long as there is an overlap between two or more lower resolution samples from two or more different projections, a higher resolution sample can be found from an intersection of lower resolution samples.

In embodiments the encoding is lossless. This may be achieved by preserving edge samples, i.e. explicitly encoding and sending the individual, higher-resolution samples from the edges of each frame in addition to the lower-resolution projections (edge samples cannot be fully reconstructed using the super resolution technique discussed above). Alternatively the edge samples need not be preserved in this manner. Instead the super resolution based technique of splitting a video into projections may be applied only to a portion of a frame (some but not all of the frame) in the interior of the frame, using more conventional coding for regions around the edges. This may also be lossless.

In other embodiments, the encoding need not be lossless—for example some degradation at frame edges may be tolerated.

The various embodiments can be implemented as an intrinsic part of an encoder or decoder, e.g. incorporated as an update to an H.264 or H.265 standard, or as a pre-processing and post-processing stage, e.g. as an add-on to an H.264 or H.265 standard. Further, the various embodiments are not limited to VoIP communications or communications over any particular kind of network, but could be used in any network capable of communicating digital data, or in a system for storing encoded data on a storage medium.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A transmitting terminal comprising:
an input for receiving a video signal comprising a plurality of frames representing a video image at different respective times, each frame comprising a plurality of higher resolution samples;
a projection generator configured to generate multiple different projections of the video image, each projection comprising a plurality of lower resolution samples representing the video image at a lower resolution, wherein the lower resolution samples of the different projections represent different but overlapping groups of the higher resolution samples which overlap spatially in a plane of the video image;
an encoder configured to encode the video signal by encoding the different projections into separate respective encoded streams; and
a transmitter configured to transmit each of the separate encoded streams to a receiving terminal over a network.

2. The transmitting terminal of claim 1, wherein each of said projections is of a different respective one of a sequence of said frames.

3. The transmitting terminal of claim 2, wherein the projection of each of said sequence of frames is a respective one of a pattern of different projections, wherein said pattern repeats over successive sequences of said frames.

4. The transmitting terminal of claim 3, wherein said pattern is predetermined, not being signalled in any of the streams from the encoding system to the decoding system.

5. The transmitting terminal of claim 1, wherein the lower resolution samples are defined by a grid structure, and the projection generator is configured to generate the projections by applying one or more different spatial shifts to the grid structure, each shift being by a fraction of one of the lower resolution samples.

6. The transmitting terminal of claim 5, wherein the projection generator is configured to apply the shifts according to a predetermined shift pattern, not being signalled in any of the streams from the encoding system to the decoding system.

7. The transmitting terminal of claim 1, where at least one of the encoded streams is decodable independently of all others of said encoded streams.

8. The transmitting terminal of claim 1, wherein the encoder is configured to encode the video signal by applying prediction coding between different ones of the projections, whereby each of one or more of the projections is encoded relative to another, base one of said projections.

9. The transmitting terminal of claim 8, wherein the encoder is configured to encode one or more of the respective frames by applying prediction coding between the projections of different frames, whereby a projection of one frame is encoded relative to another, base one of the projections of another frame.

10. The transmitting terminal of claim 9, wherein the encoding system is configured to insert a tag marking the stream carrying the base projection as a priority.

11. The transmitting terminal of claim 1, wherein the separate streams include different respective stream identifiers.

12. The transmitting terminal of claim 1, wherein the network is a packet-based network, each of the separate streams comprising a separate set of packets.

13. The transmitting terminal of claim 11, wherein the packets of each set each comprise an identifier identifying the stream to which the packet belongs.

14. The transmitting terminal of claim 5, wherein the lower resolution samples within each projection have a uniform size and shape defined by said grid.

15. The transmitting terminal of claim 1, wherein the lower resolution samples are generated by averaging the groups of the higher resolution samples.

16. The transmitting terminal of claim 1, wherein the encoder and transmitter are arranged to encode and transmit the streams dynamically as part of a live video call.

17. The transmitting terminal of claim 1, wherein the transmitter is configured to drop one or some of said streams in response to a condition of one of the transmitting terminal, the network, and the receiving terminal.

18. A network element for forwarding a video signal comprising a plurality of frames representing a video image at different respective times; the network element comprising:
transceiver apparatus arranged to receive a plurality of separate encoded video streams from a transmitting terminal over a network, each of the encoded video streams comprising a different respective one of multiple different projections of the video image, each projection comprising a plurality of lower resolution samples representing the video image at a lower resolution, wherein the lower resolution samples of the different projections represent different but overlapping groups of the higher resolution samples which overlap spatially in a plane of the video image; and
processing apparatus configured to determine whether to drop at least one of said encoded video streams in dependence on a condition of one of the network, network element and a receiving terminal, leaving one or more of the encoded video streams remaining;
wherein the transceiver is arranged to forward the one or more remaining streams to the receiving terminal over the network, but not any of the encoded video streams dropped by the processing apparatus.

19. The network element of claim 18, wherein at least one of the encoded video streams comprises a tag indicating a priority of the stream, and the processing apparatus is configured to drop at least one of the encoded video streams in dependence on the tag.

20. A computer program product for decoding a video signal comprising a plurality of frames representing a video image at different respective times, each frame comprising a plurality of higher resolution samples, the computer program product being embodied on a computer-readable storage medium and comprising code configured so as when executed on a receiving terminal to perform operations comprising:
receiving a plurality of separate encoded video streams from a transmitting terminal over a network, each of the encoded video streams comprising a different respective one of multiple different projections of the video image, each projection comprising a plurality of lower resolution samples representing the video image at a lower resolution, wherein the lower resolution samples of the different projections represent different but overlapping portions which overlap spatially in a plane of the video image;
decoding the encoded video streams so as to decode the projections;
generating higher resolution samples representing the video image at a higher resolution by, for each higher resolution sample thus generated, forming the higher resolution sample from a region of overlap between ones of the lower resolution samples from the different projections; and
outputting the video signal to a screen at the higher resolution following generation from the projections;
wherein each of said projections is of a different respective one of a sequence of said frames, and the projection of each of said sequence of frames is a respective one of a predetermined pattern of different projections, wherein said pattern repeats over successive sequences of said frames; and
the code is configured to perform said generating based on the predetermined pattern being pre-stored or pre-programmed at the receiving terminal rather than received from the transmitting terminal in any of said streams.
